(19) United States
(12) Patent Application Publication
(10) Pub. No.: US 2026/0145347 A1
(43) Pub. Date: May 28, 2026

(54) TUBULAR PAPER CUTTER STRUCTURE

(71) Applicant: EAGLE (SHAOGUAN) STATIONERY TECHNOLOGY LIMITED, SHAOGUAN (CN)

(72) Inventor: JOHNNY CHUNG HANG CHAN, SHAOGUAN (CN)

(21) Appl. No.: 19/207,385

(22) Filed: May 14, 2025

(30) Foreign Application Priority Data
Nov. 25, 2024 (CN) 202422878022.X

(51) Int. Cl. B26B 3/00; B65H 16/00

(52) U.S. Cl. CPC B26B 3/00; B65H 16/005

(57) ABSTRACT

A tubular paper cutter structure with an S-shaped paper guide channel is provided, including a tubular body. The tubular body includes a paper channel at a front end thereof, the S-shaped paper guide channel at a left end of the paper channel, and a blade at a lower end of the S-shaped paper guide channel. A paper guide tab is disposed at a right end of the S-shaped paper guide channel, a tapered surface is disposed on an inner surface of an upper end of the paper guide tab. A first inclined surface is disposed at a left end of the paper guide tab, and a second inclined surface is disposed at a right end of the paper channel. Paper is placed between the tubular body and the paper channel, the paper is non-rolled paper or rolled paper.

### TECHNICAL FIELD

The present disclosure relates to gift packaging and office supplies, and in particular to a tubular paper cutter structure with an S-shaped paper guide channel.

### BACKGROUND

Conventional paper-cutting tools on the market include utility knives, the utility knives are portable, convenient in use, and are common tools in gift shops and offices. Recently, tubular paper cutters have emerged, where a blade edge is internally housed, significantly reducing safety hazards while maintaining cutting efficiency. Additionally, the tubular paper cutters are particularly convenient for cutting rolled materials, such as decorative or wrapping paper, so as to be essential in the gift shops.

As shown in FIG. 7, a conventional tubular paper cutter mainly includes a tubular body and a blade. The tubular body serves as a base for gripping and fixing the blade. The blade serves as a blade edge for cutting paper, the blade edge is inclined relative to an axial direction of the tubular body to facilitate smooth paper cutting. The tubular body and the blade are integrated to form the tubular paper cutter. During practical use, due to variations in paper material, thickness, and stiffness, effectiveness of the blade edge in penetrating the paper may differ. Consequently, the blade may fail to penetrate the paper, causing jams at the blade edge, thereby compromising cutting performance of the tubular paper cutter. To ensure product safety, the blade edge of the conventional tubular paper cutter is internally disposed in the tubular body, thereby preventing exposure of the blade edge and mitigating potential safety hazards. Under such safety-oriented design, a paper guide channel is incorporated to direct the paper toward the blade edge, ensuring precise alignment during cutting. However, the paper guide channel and an opening of the tubular body collectively form a protruding tab, which, during operation, may result in obstruction when the paper enters the paper guide channel.

Current tubular paper cutters generally provide a straight-through paper guide channel with a blade positioned at a bottom portion thereof. When a to-be-cut portion of the paper enters the straight-through paper guide channel, the to-be-cut portion of the paper directly contacts an angled blade edge of the blade to initiate cutting. An edge of the paper interacting with the angled blade edge of the blade adopts a linear or large-curved configuration. However, due to variations in paper thickness, hardness, and strength, the edge of the paper is prone to deformation under force, thereby reducing efficiency in penetrating and cutting the paper. Concurrently, paper debris generated during cutting may accumulate at the angled blade edge, leading to clogging and further impairing cutting performance. Based on above, the present disclosure provides a tubular paper cutter structure with an S-shaped paper guide channel.

### SUMMARY

The present disclosure aims to provide a tubular paper cutter structure with an S-shaped paper guide channel to address deficiencies in the prior art, the tubular paper cutter structure is capable of eliminating need for paper bending during insertion, simplifying paper feeding operations, enhancing rigidity of a paper edge to improve blade penetration efficiency, and preventing cutting debris from clogging a blade edge to impair cutting performance, thereby resolving operational limitations described in the background.

To achieve above aims, the present disclosure provides technical solutions as follows.

The present disclosure provides the tubular paper cutter structure, including a tubular body. The tubular body includes a paper channel at a front end thereof, the S-shaped paper guide channel at a left end of the paper channel, and a blade at a lower end of the S-shaped paper guide channel. In this way, paper has no need to bend during insertion, the paper feeding operations are simplified, the rigidity of the paper edge is enhanced to improve the blade penetration efficiency, and the cutting debris is prevented from clogging the blade edge to impair the cutting performance.

Furthermore, a paper guide tab is disposed at a right end of the S-shaped paper guide channel for matching with the tubular body to provide support for guiding the paper into the S-shaped paper guide channel.

Furthermore, a tapered surface is disposed on an inner surface of an upper end of the paper guide tab, so that the paper has no need to bend during insertion, the paper feeding operations are simplified.

Furthermore, a first inclined surface is disposed at a left end of the paper guide tab, and a second inclined surface is disposed at a right end of the paper channel, which is convenient for the paper to pass through.

Furthermore, the paper is placed between the tubular body and the paper channel, the paper is non-rolled paper or rolled paper, thereby enabling the tubular paper cutter structure to accommodate cutting operations for various paper types.

Furthermore, a hand grip groove is defined at a rear end of the tubular body, ribs are uniformly distributed on an inner portion of the hand grip groove for enhancing operational stability during use.

Compared with the prior art, beneficial effects of the present disclosure are as follows.

The S-shaped paper guide channel compresses and folds the paper from a planar shape into an L-shaped configuration, thereby altering a geometry of the paper upon entry into the S-shaped paper guide channel. Such structural adjustment enhances the rigidity of the paper edge to improve blade penetration efficiency Concurrently, a guiding and positioning function of the S-shaped paper guide channel adjusts a distance and an angle between a distal end of the S-shaped paper guide channel and the blade edge, as well as a contact position between the paper edge and the blade edge. Such design prevents the paper from sliding into a junction between the blade and the tubular body during cutting, while also avoiding debris accumulation at the blade edge that could impair the cutting performance. Furthermore, the tapered surface on the inner surface of the upper end of the paper guide tab directs the paper during insertion, thereby eliminating the need for paper bending and facilitating smooth, rapid paper feeding.

### BRIEF DESCRIPTION OF DRAWINGS

FIG. 1 is a structural schematic diagram of a tubular paper cutter structure with an S-shaped paper guide channel according to the present disclosure.

FIG. 2 is a front structural schematic diagram of the tubular paper cutter structure with the S-shaped paper guide channel according to the present disclosure.

FIG. 3 is a left structural schematic diagram of the tubular paper cutter structure with the S-shaped paper guide channel according to the present disclosure.

FIG. 4 is a bottom structural schematic diagram of the tubular paper cutter structure with the S-shaped paper guide channel according to the present disclosure.

FIG. 5 is a bottom structural schematic diagram of the tubular paper cutter structure during non-rolled paper cutting.

FIG. 6 is a bottom structural schematic diagram of the tubular paper cutter structure during rolled paper cutting.

FIG. 7 is a conventional tubular paper cutter in the prior art.

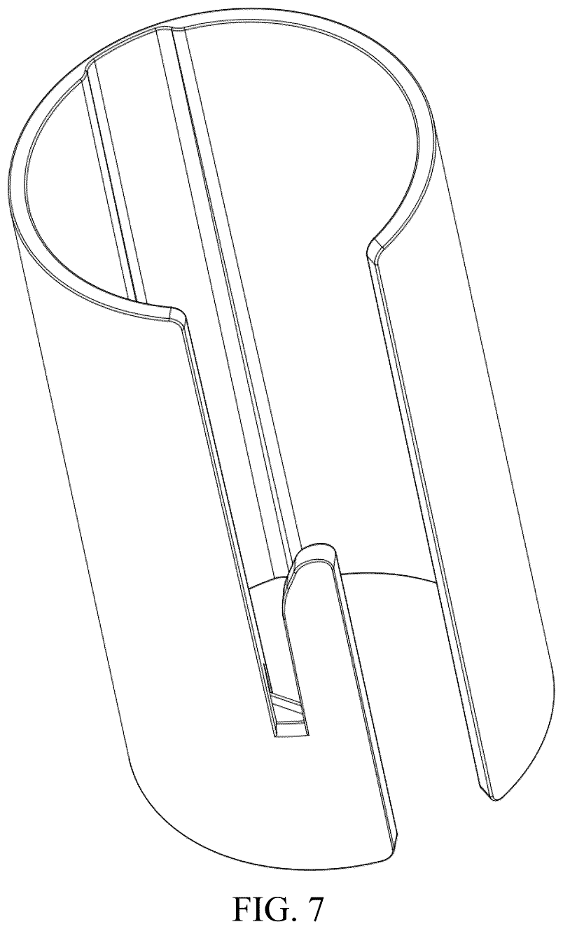

Reference numerals in the drawings: 1. tubular body; 2. blade; 3. paper channel; 4. paper guide tab; 5. first inclined surface; 6. tapered surface; 7. S-shaped paper guide channel; 8. second inclined surface; 9. hand grip groove; 10. non-rolled paper; 11. rolled paper.

### DETAILED DESCRIPTION OF EMBODIMENTS

In order to make objectives, technical solutions, and advantages of embodiments of the present disclosure clearer, the technical solutions in the embodiments of the present disclosure are clearly and completely described below with reference to accompanying drawings in the embodiments of the present disclosure. Apparently, described embodiments are a part but not all of the embodiments of the present disclosure. Components of the embodiments of the present disclosure, described and illustrated in the drawings herein, are generally enabled to be arranged and designed in a variety of different configurations.

Therefore, the following detailed description of the embodiments of the present disclosure provided in the accompanying drawings is not intended to limit a scope of the present disclosure, but merely represents selected embodiments of the present disclosure. All other embodiments obtained by those who skilled in the art based on the embodiments of the present disclosure without creative efforts shall fall within a protection scope of the present disclosure.

It should be noted that similar reference numerals and letters refer to similar items in the following drawings, and therefore, once an item is defined in one figure, it is not necessary to further define and explain in subsequent figures.

In the description of the present disclosure, it should be noted that orientations or position relationships indicated by terms “inner”, “lower”, etc. are based on orientations or position relationships shown in the accompanying drawings, or orientations or position relationships of normal placement when a product is used are merely for ease of description, rather than indicating or implying that a device or element referred to has to have a specific orientation or be constructed and operated in a specific orientation, and therefore cannot be understood as a limitation to the present disclosure. In addition, terms “first”, “second”, etc. are only used to distinguish descriptions, and cannot be understood as indicating or implying relative importance.

Further, in the description of the present disclosure, it should be noted that, unless expressly specified and limited otherwise, terms “disposed” and “connected” should be understood in a broad sense, for example, may be a fixed connection, a detachable connection, or an integral connection; and may be a mechanical connection, may be a direct connection, or may be indirectly connected by using an intermediate medium, and may be a communication inside two elements. For those who skilled in the art, specific meanings of above terms in the present disclosure may be understood according to specific situations.

In the present disclosure, unless otherwise expressly specified and defined, expression “a first feature being above or below a second feature” may include both: (1) direct contact between the first feature and the second feature; and (2) indirect contact where the first feature and the second feature are in contact through one or more additional features between them. Additionally, terms “above”, “upper”, and “on top of” with respect to the second feature encompass: (a) the first feature being disposed directly above or diagonally above the second feature; or (b) simply indicating that the first feature is at a higher horizontal elevation compared to the second feature. Similarly, terms “below”, “lower”, and “underneath” with respect to the second feature include: (a) the first feature being disposed directly below or diagonally below the second feature; or (b) simply indicating that the first feature is at a lower horizontal elevation compared to the second feature.

It should be understood that, in cases where there is no conflict, the embodiments of the present disclosure and features within these embodiments may be combined with one another.

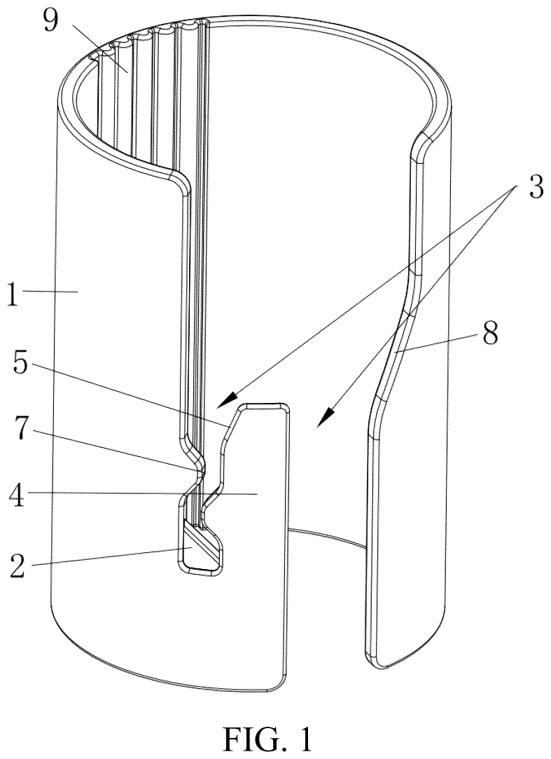

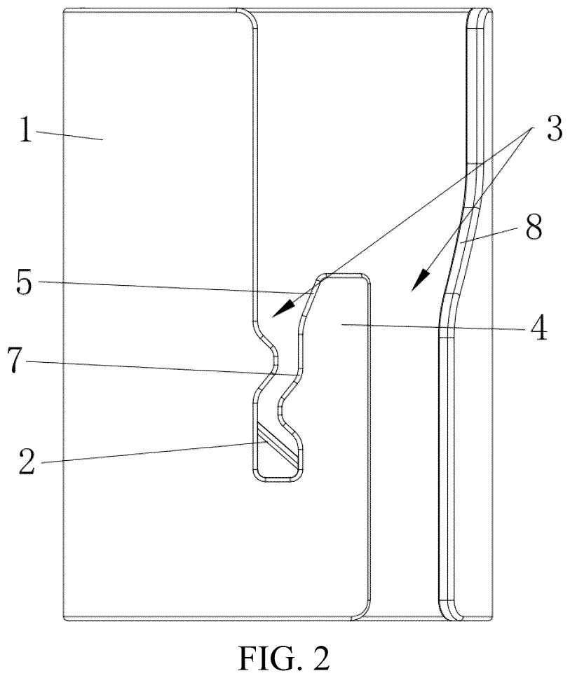

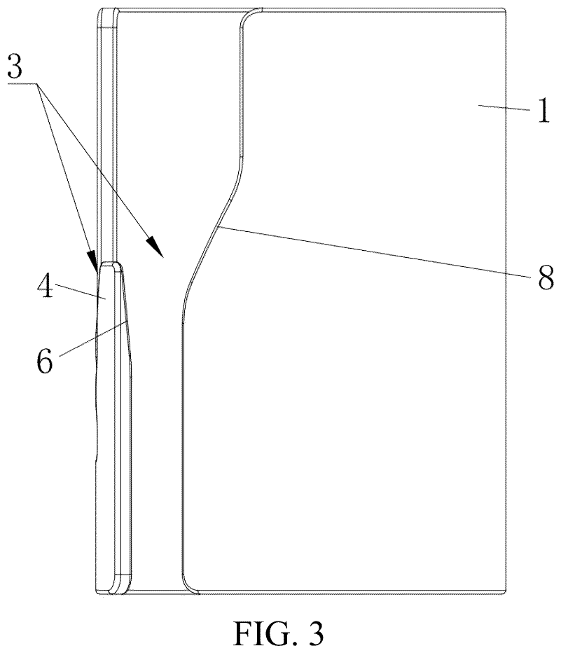

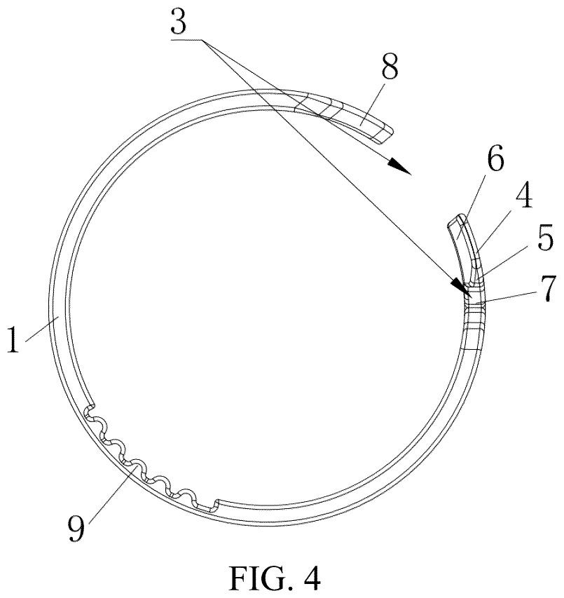

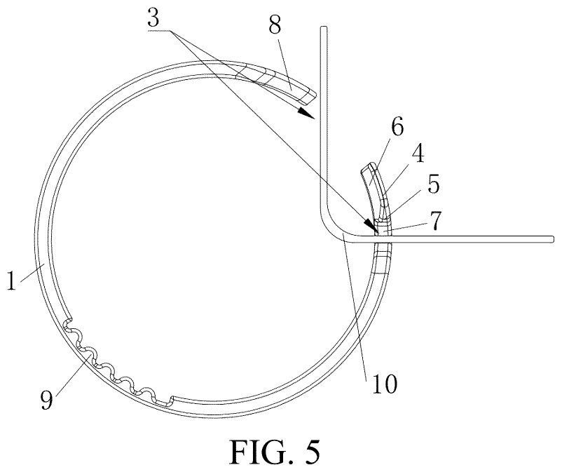

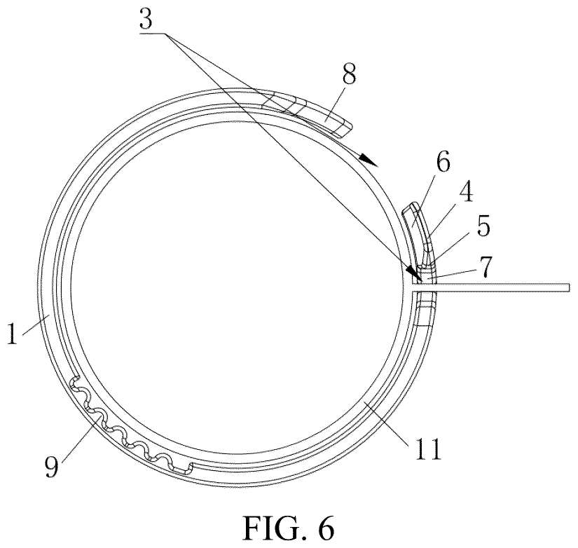

Please refer to FIGS. 1-6, the embodiments of the present disclosure provide a tubular paper cutter structure with an S-shaped paper guide channel 7, including a tubular body 1. The tubular body 1 includes a paper channel 3 at a front end thereof, the S-shaped paper guide channel 7 at a left end of the paper channel 3, and a blade 2 at a lower end of the S-shaped paper guide channel 7. A paper guide tab 4 is disposed at a right end of the S-shaped paper guide channel 7, a tapered surface 6 is disposed on an inner surface of an upper end of the paper guide tab 4. A first inclined surface 5 is disposed at a left end of the paper guide tab 4, and a second inclined surface 8 is disposed at a right end of the paper channel 3. The first inclined surface 5 and the second inclined surface 8 provide guiding surfaces for the paper during sliding, enabling precise and stable entry of the paper into the paper channel 3 and the S-shaped paper guide channel 7. The paper is placed between the tubular body 1 and the paper channel 3, the paper is non-rolled paper 10 or rolled paper 11. A hand grip groove 9 is defined at a rear end of the tubular body 1, ribs are uniformly distributed on an inner portion of the hand grip groove 9. To operate the tubular paper cutter structure, the non-rolled paper 10 passes through the paper channel 3, or the rolled paper 11 passes through an inner cavity of the tubular body 1, such that a to-be-cut portion of the non-rolled paper 10 or the rolled paper 11 enters the S-shaped paper guide channel 7. The tapered surface 6 on the inner surface of the upper end of the paper guide tab 4 provides directional guidance, ensuring that an inner surface at a head of the paper guide tab 4 is elevated above a paper plane. Such configuration allows straight insertion of the paper without bending, significantly simplifying paper feeding. Users grip the hand grip groove 9 on the tubular body 1 to control the tubular paper cutter structure to drive the tubular body 1 to move. As the paper advances, the S-shaped paper guide channel 7 compresses and folds the paper from a planar shape into an L-shaped configuration, thereby adjusting rigidity of a contact edge of the non-rolled paper 10 or the rolled paper 11 with a blade edge of the blade 2, which prevents curling of a paper edge and increases a success rate of blade penetration during cutting. Additionally, the S-shaped paper guide channel 7 defines an initial cutting position of the non-rolled paper 10 or the rolled paper 11 relative to the blade edge of the blade 2. Such guiding and positioning function of the S-shaped paper guide channel 7 adjusts a distance and an angle between a distal end of the S-shaped paper guide channel 7 and the blade edge of the blade 2, as well as a contact position between the paper edge of the non-rolled paper 10 or the rolled paper 11 and the blade edge of the blade 2, thereby preventing the non-rolled paper 10 or the rolled paper 11 from sliding into a junction between the blade 2 and the tubular body 1 during cutting, while also avoiding debris accumulation at the blade edge that could impair cutting performance.

An operation principle of the tubular paper cutter structure with the S-shaped paper guide channel 7 of the present disclosure is as follows.

During operations, the non-rolled paper 10 passes through the paper channel 3, or the rolled paper 11 passes through the inner cavity of the tubular body 1, such that the to-be-cut portion of the non-rolled paper 10 or the rolled paper 11 enters the S-shaped paper guide channel 7. The tapered surface 6 on the inner surface of the upper end of the paper guide tab 4 provides the directional guidance, ensuring that the inner surface at the head of the paper guide tab 4 is elevated above the paper plane. Such configuration allows the straight insertion of the paper without bending, significantly simplifying the paper feeding. The users grip the hand grip groove 9 on the tubular body 1 to control the tubular paper cutter structure to drive the tubular body 1 to move. As the paper advances, the S-shaped paper guide channel 7 compresses and folds the paper from the planar shape into the L-shaped configuration, thereby adjusting the rigidity of the contact edge of the non-rolled paper 10 or the rolled paper 11 with the blade edge of the blade 2, which prevents curling of the paper edge and increases the success rate of the blade penetration during cutting. Additionally, the S-shaped paper guide channel 7 defines the initial cutting position of the non-rolled paper 10 or the rolled paper 11 relative to the blade edge the blade 2. Such guiding and positioning function of the S-shaped paper guide channel 7 adjusts the distance and the angle between the distal end of the S-shaped paper guide channel 7 and the blade edge of the blade 2, as well as the contact position between the paper edge of the non-rolled paper 10 or the rolled paper 11 and the blade edge of the blade 2, thereby preventing the non-rolled paper 10 or the rolled paper 11 from sliding into the junction between the blade 2 and the tubular body 1 during cutting, while also avoiding debris accumulation at the blade edge that could impair the cutting performance.

The above are only embodiments of the present disclosure, and are not therefore intended to limit a patent scope of the present disclosure, and any equivalent structure or equivalent process transformation made by using the description and drawings of the present disclosure, or applied directly or indirectly to other related technical fields, are all included in the protection scope of the present disclosure.

What is claimed is:

1. A tubular paper cutter structure, comprising:
a tubular body;
wherein the tubular body comprises a paper channel at a front end thereof, an S-shaped paper guide channel at a left end of the paper channel, and a blade at a lower end of the S-shaped paper guide channel.

2. The tubular paper cutter structure according to claim 1, wherein a paper guide tab is disposed at a right end of the S-shaped paper guide channel, and a tapered surface is disposed on an inner surface of an upper end of the paper guide tab.

3. The tubular paper cutter structure according to claim 2, wherein a first inclined surface is disposed at a left end of the paper guide tab, and a second inclined surface is disposed at a right end of the paper channel.
